(19) United States
(12) Patent Application Publication
(10) Pub. No.: US 2011/0135198 A1
(43) Pub. Date: Jun. 9, 2011

(54) CHROMINANCE ENCODING AND DECODING OF A DIGITAL IMAGE

(75) Inventor: Daniel B. SCHULER, Los Angeles, CA (US)

(73) Assignee: Xerox Corporation, Norwalk, CT (US)

(21) Appl. No.: 12/633,256

(22) Filed: Dec. 8, 2009

(51) Int. Cl. G06K 9/36; G06K 9/00

(52) U.S. Cl. 382/166; 382/251

(57) ABSTRACT

What is disclosed is a system and method for encoding and decoding chrominance values of a digital images. In one example embodiment, a digitized image comprising a plurality of pixels is received. A degree of chrominance precision is determined for a selected pixel based upon the luminance level associated with the selected pixel. Each of the chrominance values for the selected pixel are quantized based upon the chrominance precision. The quantized chrominance values for the selected pixel are then output. In such a manner, pixels associated with high or low luminance levels have chrominance values that are encoded with less precision than pixels associated with intermediate luminance levels. Varying the degree of precision of chrominance encoding corresponds directly to observed human-eye sensitivity where determining an exact color or hue of very bright or dark patches can be difficult relative to patches having an intermediate brightness. Various embodiments have been disclosed.

### TECHNICAL FIELD

The present invention is directed to systems and methods for encoding a digital image based upon the luminance and chrominance values of the image's pixels.

### BACKGROUND

Electronic storage of spatial image data is often accomplished by representing an array of picture elements, commonly referred to as “pixels,” that define the image. Each pixel in many cases is encoded using a color space that defines values for luminance and chrominance dimensions. Such representations are used by, for example, the well established JPEG and MPEG encoding standards. JPEG is an acronym for Joint Photographic Experts Group and MPEG is an acronym for Moving Picture Experts Group, which are the two groups that defined the encoding standards referred to by their names.

Color space components for each pixel generally have three values or dimensions. One value is a “luminance” value that defines a quantity that is conceptually related to pixel “brightness.” The other two of the three values or dimensions generally define two “chrominance” values or dimensions. The chrominance values primarily define color components of the pixel. Examples of chrominance dimensions include the Cr (red/green) and Cb (blue/yellow) components. In general, conventional systems digitally encode the luminance and chrominance values of every pixel with the same resolution, such as eight digital bits for each value. In such systems, the resolution used to encode luminance and chrominance values is chosen to provide sufficient encoding for the most demanding image data. Such encoding schemes use an equal amount of data to encode digital images without regard to the nature of the image characteristics, and therefore consume a maximum amount of data for a given resolution requirement for a “worst case” image.

Conventional image encoding systems generally quantize chrominance values with the same degree of precision regardless of luminance value or luminance levels associated with a given pixel. Consistently encoding chrominance without regard to luminance results in using more data bits being consumed for storing chrominance than are significant for the human visual system. Such systems are inefficient and introduce unnecessary redundancies into the encoded image.

Accordingly, what is needed in this art are increasingly sophisticated systems and methods for efficiently encoding pixel data of digitally encoded images which takes into account luminance values and thus reduces the amount of chrominance data being stored.

### BRIEF SUMMARY

What is disclosed is a novel system and method for encoding and decoding chrominance values of digital images. In one example embodiment, a digitized image comprising a plurality of pixels is received. A degree of chrominance precision is determined for a selected pixel based upon the luminance level associated with the selected pixel. Each of the chrominance values for the selected pixel is quantized based upon the chrominance precision. The quantized chrominance values for the selected pixel are then output. In such a manner, pixels associated with high or low luminance levels have chrominance values that are encoded with less precision than pixels associated with intermediate luminance levels. Varying the degree of precision of chrominance encoding corresponds directly to observed human-eye sensitivity where determining an exact color or hue of very bright or dark patches can be difficult relative to patches having an intermediate brightness.

In one example embodiment, a digital representation is received of an image having a plurality of pixels. Each pixel in the plurality of pixels has a luminance value and at least one chrominance value associated therewith. The luminance values associated with a given pixel may alternatively be derived from an average of luminance values of pixels in a pre-defined neighborhood of pixels surrounding the pixel. One example of a pre-defined neighborhood of pixels is an 8×8 pixel Discrete Cosine Transform (DCT) block of pixels as are encoded according to the JPEG and MPEG standards. In the case of a DCT block as defined by the JPEG and MPEG standard, the DC value of the DCT block represents the average luminance for that block and is therefore used as the luminance value associated with each pixel in that block. For each selected pixel in the received image, the following steps are repeatedly performed. First, a degree of chrominance precision is determined for the selected pixel based upon the selected pixel's associated luminance value. The degree of chrominance precision has a substantially minimum value when the luminance value associated with the selected pixel is near either a maximum luminance value or near a minimum luminance value. The degree of chrominance precision is based upon a human eye sensitivity and increases as the luminance value varies away from either the minimum or maximum luminance value of the color space to an intermediate luminance value between the maximum and minimum luminance. Each of the at least one chrominance value associated with the selected pixel is then quantized based upon the selected pixel's determined degree of chrominance precision. In one embodiment the quantized chrominance values for the selected pixel are retrieved from a quantization table, among a plurality of tables, based upon any of the at least one chrominance value and the luminance value associated with the selected pixel. Quantization produces at least one quantized chrominance value for each of the at least one chrominance values. The quantized chrominance values for any of the selected pixels can then be output to a storage device. The associated luminance values and the determined degree of chrominance precision can also be output to the storage device or stored to a database for subsequent retrieval.

Many features and advantages of the above-described method will become readily apparent from the following detailed description and accompanying drawings.

### BRIEF DESCRIPTION OF THE DRAWINGS

The foregoing and other features and advantages of the subject matter disclosed herein will be made apparent from the following detailed description taken in conjunction with the accompanying drawings, in which:

FIG. 1 is a processing block diagram of one embodiment implementing the present encoding method;

FIG. 2 illustrates a pixel neighborhood as processed by one embodiment of the present encoding method;

FIG. 3 is a chrominance precision versus luminance graph as incorporated by one embodiment of the present method;

FIG. 4 is an image encoding method flow diagram of one embodiment of the present method;

FIG. 5 is an image decoding method flow diagram of one embodiment of the present method; and

FIG. 6 illustrates a block diagram of one example embodiment of a special purpose computer useful for implementing one or more aspects of the present method.

### DETAILED DESCRIPTION

What is provided are a system and method for efficiently encoding digital color images by quantizing chrominance values for each pixel with an amount of chrominance precision which is dependent on the luminance level associated with that pixel. The luminance level associated with a pixel is able to be, for example, the luminance level of that pixel or a combination of luminance levels of pixels in a neighborhood of the pixel. One embodiment uses the eight-by-eight (8×8) pixel block used for Discrete Cosine Transforms (DCT) as used by, for example, JPEG and MPEG encoding as one example of a neighborhood of the pixels. In the case of a neighborhood defined by the eight-by-eight (8×8) pixel DCT block as defined by the JPEG and MPEG standard, the DC value of the luminance DCT block is the average luminance for that block and is the average luminance value that is associated with each pixel in that block. The present method encodes each pixel's chrominance with a varying degree of resolution based upon the pixels' associated luminance level. In the case of using DCT blocks, the chrominance values used to store each pixel in a particular chrominance DCT block are scaled based upon a magnitude of the luminance value associated with that DCT block (such as the DC value of the luminance DCT block). In such a manner, the stored precision of chrominance values can be adjusted to encode the chrominance values of pixels based upon observed human eye sensitivities to chrominance for varying levels of luminance where determining an exact color or hue of very bright or very dark patches can be difficult relative to patches having an intermediate brightness level.

It should be understood that one of ordinary skill in this art should be readily familiar with many facets of color science such as, but not limited to, color space, color gamuts, the processing, manipulating, and encoding images using data conserving techniques, including representing and encoding digital color images as combinations of luminance and chrominance data, and other related techniques and algorithms common to the art of color science. Those of ordinary skill would be familiar with the text: “Digital Color Imaging Handbook”, 1^{st} Ed., CRC Press (2003), ISBN-10: 084930900-X, ISBN-13: 97808-4930-9007, and “Control of Color Imaging Systems: Analysis and Design”, Lalit K. Mestha and Sohail A. Dianat, CRC Press (2009), ISBN-13: 97808-4933-7468, both of which are incorporated herein in their entirety by reference.

A “color image” is to a pattern of physical light comprised of known colors of the light spectrum which are visible by the human eye. When reduced to print, the image comprises a plurality of pixels arrayed on a media substrate or display device.

A “digital color image” (or “digital image data”) refers to a digitized representation of a color image. Digital image data of various embodiments include, for example, single images, a series of images that define a moving picture, or any other suitable collection of images. Digital image data can be stored as, for example, a bitmap of the image. A bitmap is a data structure representing a generally rectangular grid of pixels or individual points of color values. A bitmap of an image generally corresponds bit-for-bit with the original image, generally in a same format used in the display device's video memory, or maybe as a device-independent bitmap. The bitmap is characterized by the width and height (X and Y dimensions) of the image in pixels and by the number of bits-per-pixel (a color depth) which determines the number of colors a given pixel can represent. A digital color image is intended to include digitized representations of black/white images.

A “L*a*b* color space” is a color-opponent space whose coordinates are given by {L*, a*, b*} with dimension L* for luminance and a* and b* for the color-opponent dimensions based upon non-linearly compressed CIE XYZ color space coordinates. Luminance (L) is a photometric quantity which, in essence, is the effect of radiance on our eyes. Radiance is the physical quantity related to light intensity, i.e., the power of the light spreading out in some solid angle over an area. Luminance is the integration of radiance weighted with a curve, which describes how efficiently different wavelengths of light trigger visual receptors in the eye. Brightness is the subjective visual experience of luminance, i.e., the effect of luminance on the brain. The luminance value of a pixel is the value related to a perceived brightness of that pixel. Chrominance (a) is the chrominance of a first channel. Chrominance (b) is the chrominance of a second channel. The chrominance value of a pixel is the one or more values that define a pixel's color or hue. Luminance and/or chrominance values can be specified relative to a color model.

A “pixel” refers to the smallest segment into which an image can be divided. Received pixels of an input image are associated with a color value defined in terms of a color space, such as color, intensity, lightness, brightness, or some mathematical transformation thereof. Pixel color values may be converted to a chrominance-luminance space using, for instance, a RBG-to-YCbCr converter to obtain luminance (Y) and chrominance (Cb,Cr) values. It should be appreciated that pixels may be represented by values other than RGB or YCbCr. Chrominance (a) is the chrominance of a first channel. Chrominance (b) is the chrominance of a second channel.

A “neighborhood of a pixel” refers to pixels in a neighborhood surrounding a current pixel of interest.

A “pixel block” refers to a block of pixels of an image which have been encoded according to a standardized compression format such as, for example, JPEG and MPEG. These formats generally divide each of the luminance and two chrominance sets of data for an image, or of each image of a motion picture, into a respective series of eight-by-eight (8×8) pixel blocks. One embodiment of the present encoding method operates on the pixels blocks of JPEG and MPEG formatted data.

“Luminance level associated with a pixel” refers to a luminance value of a pixel or a combination of luminance values of pixels within a neighborhood of the pixel.

“Chrominance precision” refers to a level of precision with which chrominance values are to be encoded for a particular pixel, as is fully described herein further. One embodiment hereof defines a chrominance precision as a function which has values that increase as the luminance level associated with a pixel varies from a minimum luminance value (or a maximum luminance value) to an intermediate luminance value.

A “quantized chrominance value” refers to a chrominance value that is to be encoded for a pixel according to values stored in quantization tables, in a manner more fully described herein. Encoded chrominance values have a reduced precision relative to the digital color image data from which they are derived.

“Quantization tables” are look-up tables that contain either precision values to be used to produce quantized chrominance values or that contain quantized chrominance values themselves. Quantization tables are able to contain either actual values to be output, or coefficients used to scale each corresponding DCT-block value. Quantization tables that contain quantized chrominance output values to be used to encode a pixel are indexed by a luminance level associated with that pixel.

An “image input device” is any device capable of obtaining color pixel values from a color image. The set of image input devices is intended to encompass a wide variety of devices such as, for example, digital document devices, computer systems, memory and storage devices, networked platforms such as servers and client devices which can obtain pixel values from a source device, and image capture devices. The set of image capture devices includes scanners, cameras, photography equipment, facsimile machines, photo reproduction equipment, digital printing presses, xerographic devices, and the like. A scanner is one image capture device that optically scans images, print media, and the like, and converts the scanned image into a digitized format. Common scanning devices include variations of the flatbed scanner, generally known in the arts, wherein specialized image receptors move beneath a platen and scan the media placed on the platen. Modern digital scanners typically incorporate a charge-coupled device (CCD) or a contact image sensor (CIS) as the image sensing receptor(s). A signal of the scanned image data is produced by the scanning device. Such a digital signal contains information about pixels such as color value, intensity, and location within the scanned image.

An “image output device” is any device capable of rendering an image. The set of image output devices includes color marking devices such as, for instance, digital document reproduction device and other xerographic systems, photographic production and reproduction equipment as are widely known in commerce. An inkjet printer is one example image output device which receives a signal of an image and reduces the image to a viewable form by the visual integration of inks deposited onto a surface of a media substrate. An image output device includes various display devices such as monitors, projectors, holographic systems, and the like, which are also capable of rendering an image.

To “render” is to transform a signal of an image from one state to another such as, for example, receiving a signal of an image and reducing that signal to a viewable form such as a hardcopy print of the image. Rendering is also intended to include storing images to a memory or storage device, or otherwise communicating the image signal to another device such as a storage device. Such communication may take the form of transmitting, wirelessly or via a wire or cable, the image signal over a network such as a LAN or Internet.

A “storage device” refers to any device or system capable of storing luminance and/or chrominance values of a digital color image. One example storage device is a database, as are well known in the arts, placed in communication with any of: a computer system, workstation, server, or other device, that is either remote from or collocated with the device hosting a computing process that stores/retrieves the image data in the database. Storage devices include RAM, ROM, cache memory, CD-ROM, DVD, flash drives, USB devices, internal/external hard drives, and other media or devices capable of storing electronic documents or images thereof.

“Image resizing” is understood to mean both image enlargement and image reduction wherein encoding is performed accordance with the methods disclosed herein.

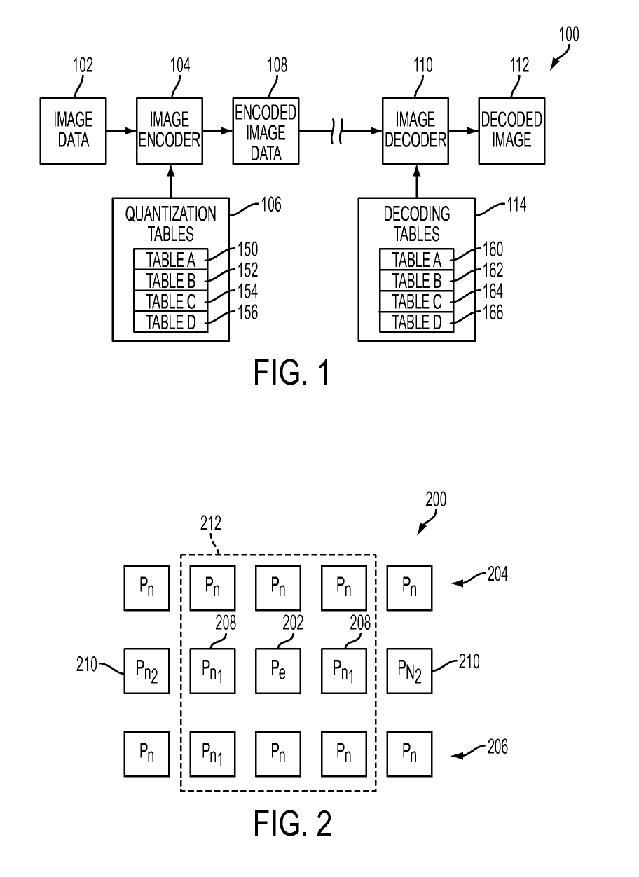

Reference is now made to FIG. 1, which is a processing block diagram 100 of one embodiment implementing the present method. In the illustrated example, digital image data 102 is received and processed by an image encoder 104. Various embodiments of the present invention are able to receive digital image data from various sources and in different formats, for example, by electronic communications from a database, camera device, scanner, and the like. Further embodiments are able to incorporate image capture devices, such as hard copy scanners, photographic devices, and the like. The digital image data 102 of one embodiment includes a number of pixels. Each pixel in the digital image data includes a luminance value and two chrominance values. As is understood by practitioners of ordinary skill in the relevant arts, one example of data dimensions defining each pixel in the image data 102 includes a luminance value, commonly represented by the symbol “Y,” and chrominance values that include a first chrominance value representing a “Cr” dimension and second chrominance value representing a “Cb” dimension. This pair of chrominance values is often referred to as a “chrominance vector” because two independent values are contained therein. The operation of one embodiment compresses an image by establishing a set of Y (luminance)/CrCb (chrominance vector) pairs. The Y component indexes a table containing quantization mappings for the CrCb vector. Various embodiments of the present invention are able to use either scalar quantization or vector quantization of the CrCb vector. One embodiment uses scalar quantization. Using scalar quantization in one embodiment introduces only one additional step after the Discrete Cosine Transform (or DCT) that is typically part of conventional JPEG or MPEG compression. Such embodiments perform this quantization before entropy coding in order to, on average, process fewer bits in the entropy coder stage.

The image encoder 104, as defined in more detail below, processes the image data by defining a chrominance precision for each pixel within the image data 102. The chrominance precision determined for each pixel by the image encoder of one embodiment is based upon a luminance level associated with that pixel. As is described below in further detail, the luminance level associated with each pixel is able to be one of A) the luminance value of that pixel, B) a combination of luminance values of pixels neighboring that pixel, or C) a combination of luminance values of that pixel and of pixels neighboring that pixel. Further, the image encoder 104 of one embodiment is able to determine, based upon corresponding luminance levels, independent degrees of precision for each of the two chrominance dimensions. These independent degrees of precision are able to be based upon, for example, a heuristically determined sensitivity of the human eye to those chrominance dimensions at various luminance levels. It is to be noted that one embodiment of the present invention determines chrominance precision for encoding chrominance data based upon a luminance level associated with the pixel, which is able to include, for example, the luminance value of that pixel or of a combination of luminance values of neighboring pixels of the pixel, where the combination is an average or mean of those luminance values. The encoded chrominance value precision of one embodiment is not based upon, for example, luminance activity, luminance slopes, or spatial frequency components of the luminance characteristics of the image being encoded.

The image encoder 104 of one embodiment uses the luminance level associated with at least each pixel as an index into a set of quantization tables 106. One embodiment uses several quantization mappings that have different dynamic ranges depending on the associated luminance level associated with a given picture element or of neighboring picture elements. The illustrated quantization tables 106 are shown to have four tables, a table A 150, a table B 152, a table C 154 and a table D 156. Each of these four tables uses different chrominance quantization precisions, or resolutions. The image encoder 104 selects one of these quantization tables for quantizing the chrominance value of a pixel based upon the luminance level associated with that pixel. Further embodiments are able to use any suitable number of quantization tables to provide a desired amount of quantization precision granularity based upon luminance levels associated with pixels being encoded.

In one embodiment, a coder/decoder maps various luminance levels to different chrominance quantization tables in order to save bits in the coded output. These chrominance quantization tables are determined empirically in one embodiment by method including, for example, optimizing Signal-to-Noise Ratio (SNR), to objectively maintain image quality as perceived by a human eye awhile reducing the number of coded bits. Some embodiments sub-sample chrominance components of an image. In such systems, more than one luminance component is combined by, for example, averaging, to determine an index to a particular chrominance quantization table.

One embodiment hereof incorporates observed human eye sensitivities to reduce the resolution of encoded chrominance data of each pixel based upon a luminance level associated with that pixel. For instance, when the luminance value of a pixel, or of neighboring pixels, is high, the subjective response of the human eye has more difficulty distinguishing between more shades of off-white than between shades of a more fully saturated color. Likewise, when the luminance value of a pixel or of neighboring pixels is low, the human eye has more difficulty distinguishing between many shades of a nearly black color. Additionally, the human eye has been observed to have more difficulty differentiating between many shades of yellow than between shades of green. One embodiment of the present method more efficiently encodes image information by adjusting the encoding resolution of chrominance data of each pixel to incorporate the reduced human eye sensitivities.

The image encoder 104 of one embodiment is able to use the luminance level associated with each pixel to either A) retrieve a chrominance precision value to be used to encode that pixel, or B) combine the luminance level associated with the pixel and the actual chrominance vector of that pixel to retrieve the chrominance vector values to encode for that pixel. The quantization tables 106 of various embodiments are able to correspondingly store either chrominance precision values that are to be used for each luminance level encountered in the received image data 102, or actual output chrominance values to be encoded into output image data where the precision of those output chrominance values depends upon the value of the luminance level associated with the pixel being encoded as well as the chrominance values of that pixel as contained in the received image data. The image encoder of one embodiment produces encoded image data 108. The encoded image data includes luminance and chrominance data for each pixel where the precision, i.e., the number of bits used to convey, the chrominance data is varied dependent upon the luminance level associated with each pixel. The precision of the luminance value encoded into the encoded image data of one embodiment is not altered relative to the luminance value specified for that pixel in the received image data 102.

Further embodiments of the present invention operate in conjunction with encoding image data according to a Joint Photographic Experts group (JPEG) or Motion Picture Experts Group (MPEG) format. As is understood by practitioners of ordinary skill in the relevant arts, digitally stored images are able to be compressed and encoded according to a format commonly referred to as JPEG, and digitally stored motion pictures are able to be compressed and encoded through a similar format commonly referred to as MPEG. These formats generally divide each of the luminance and two chrominance sets of data for an image, or of each image of a motion picture, into a respective series of eight-by-eight (8×8) pixel blocks. In accordance with an example of these standards, Discrete Cosine Transforms (DCTs) are performed on each 8×8 pixel block for each of the luminance and two chrominance components to produce a DCT output with amplitudes stored in a corresponding 8×8 matrix. As is further understood by practitioners of ordinary skill in the relevant arts, in accordance with an example of the JPEG format, the amplitudes of the DCT output for each pixel block of the luminance and both chrominance components are then quantized with a quantization matrix to reduce the range of values in these DCT values and increase the length of sequences of values that are equal to zero. These quantized values are then stored in an output by use of an entropy encoding process.

One embodiment of the present invention that operates with JPEG and MPEG formatted data uses different quantization matrices to quantize the chrominance DCT output blocks to dynamically adjust the quantization of the DCT output of one or both chrominance data sets according to the average luminance value of the DCT block, such as is specified by the upper left value of the luminance DCT output matrix for that pixel block. Based upon the average luminance value for a particular pixel block, one embodiment of the present invention adjusts a degree of precision by adjusting the quantization matrix to be used for that pixel block. One embodiment stores a number of quantization matrices and adjustment of the quantization matrix is performed by selecting one of the stored quantization matrices based upon the desired degree of quantization, such as determined by the average luminance value of the pixel block. It is to be understood that in one embodiment, each pixel block is able to use a different quantization matrix for quantizing the chrominance data of that pixel block according to the average luminance of that pixel block. It is further to be understood that the two chrominance data sets are able to be quantized by different quantization matrices or by the same quantization matrix according to the requirements of the various designs.

As an alternative to using different quantization matrices, further embodiments are able to adjust, by reducing, the degree of precision, based upon the average luminance of a DCT block, of the stored DCT outputs for the chrominance values of that DCT block. These reduced precision DCT outputs for the chrominance data are then entropy encoded in one embodiment.

The encoded image data 108 of one embodiment reduces the amount of data required to store the digital image defined by the received digital image 102. The data defining the encoded image data is able to be efficiently stored and/or communicated via any suitable techniques. The encoded image data is received by an image decoder 110. As described below, the image decoder of one embodiment decodes the encoded image data to create a decoded image 112 that is in a format that is compatible with processing by conventional techniques. In one embodiment, decompression of an encoded image performs the above described processing in reverse. In an example of decoder processing associated with JPEG or MPEG image formats, entropy coding is reversed first and followed by a Y-indexed CrCb decoding to accommodate the encoding quantization described above. An Inverse DCT (IDCT) is then applied. The image decoder performs a decoding process that is an inverse of the encoding process described herein. The image decoder of one embodiment utilizes decoding tables 114, which correspond to the quantization tables 106 described above. The illustrated decoding tables are shown to include four decoding tables, a table A 160, a table B 162, a table C 164, and a table D 166. These four tables within the decoding tables contain mappings that are inverses of the mappings stored in the four corresponding quantization tables. The image decoder of one embodiment receives encoded chrominance values of pixels in the encoded image data 108 and is able to determine the decoded chrominance values by indexing into the proper decoding table within the decoding tables based upon the luminance level associated with that pixel. The encoding process performed by the image encoder does not alter the luminance value that is stored in the encoded image data, and therefore the luminance value stored in the encoded image data is able to be used to index into the decoding tables.

Reference is now made to FIG. 2, which illustrates a pixel neighborhood 200 as processed by one embodiment of the present method. The pixel neighborhood 200 illustrates a portion of an image contained within the received image data 102, described above. Pixel neighborhoods are further defined within the encoded image data 108 for processing by the image decoder 110, described above. A pixel being encoded, identified as Pe 202, is shown. On either side of Pe 202 are nearest neighboring pixels Pn1 208. Beyond each of the nearest neighboring pixels Pn1 208 are next nearest neighboring pixels Pn2 210. The illustrated pixel neighborhood 200 further shows three rows of pixels. In addition to the row containing Pe 202, an upper pixel row 204 is above the Pe 202 and a lower pixel row 206 is below the Pe 202.

Various embodiments of the present method encode output pixel data with chrominance values encoded with a chrominance precision for each pixel that is determined based on a luminance quantity that is associated with each pixel. One embodiment hereof determines chrominance precisions to use for each pixel based only upon the luminance level associated with that pixel. Further embodiments determine chrominance precisions to use for each pixel based also upon a determined combination of luminance values of pixels within a pre-defined neighborhood of the selected pixel. An example of a pre-defined neighborhood over which luminance values of pixels are averaged by one embodiment of the present method is illustrated as a neighborhood 212. The neighborhood 212 includes the Pe 202, the nearest neighboring pixels Pn2 210, and the pixels of the upper pixel row 204 and the lower pixel row 206 that are closest to the Pe 202. The next nearest neighboring pixels Pn2 210 are not included in the neighborhood 212. In this example, the luminance values of all of the pixels in the neighborhood 212 are combined, such as by an averaging, a weighted averaging, or any other combination technique, in order to determine an associated luminance level associated with the pixel. Further embodiments of the present method are able to use pre-defined neighborhoods of any shape or contour, such as including all pixels within a circle or square of a pre-determined number of pixels away from the Pe 202, and the like. Some embodiments do not include Pe 202 in the pre-defined neighborhood.

Further embodiments operate on, for example, 8×8 pixel blocks as are used by, for example, JPEG and/or MPEG encoding. Such embodiments use the so called “DC” value of the luminance DCT output as a luminance level upon which to base the degree of chrominance quantization to be applied to the two chrominance DCT outputs for that pixel block. In such embodiments, quantization matrices for the two chrominance DCT outputs for that pixel block are able to be selected from a number of stored quantization matrices based on the DC value of the luminance data for that pixel block.

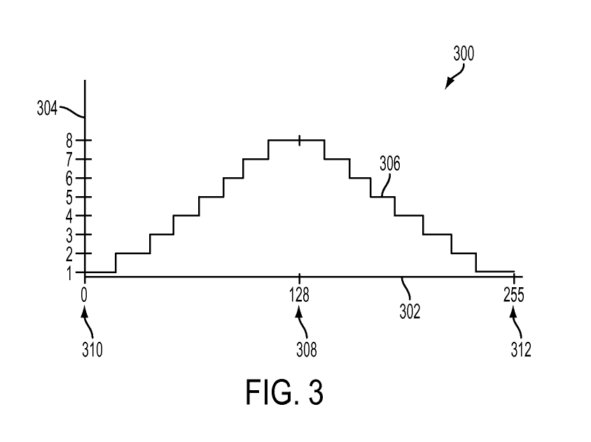

Reference is now made to FIG. 3, which is a chrominance precision versus luminance graph 300 as incorporated by one embodiment of the present method. The illustrated chrominance precision versus luminance graph 300 has a luminance axis 302 and a chrominance precision axis 304. The values along the luminance axis 302 of one embodiment correspond to the luminance level associated with a received pixel within the received image data 102.

The values along the chrominance precision axis 304 of one embodiment correspond to a number of data bits that are used to encode chrominance values for each pixel in the encoded image data 108. In one embodiment, luminance values are encoded using eight bits, and therefore have a value range between a minimum luminance value of zero, illustrated at point 310, and a maximum luminance value 255, illustrated at point 312. Other embodiments are able to use other representations of luminance values and therefore have different ranges than those depicted in this example. In one embodiment, chrominance values are encoded with data having between one and eight bits, which corresponds to the value range for the illustrated chrominance precision axis 304. The illustrated chrominance precision versus luminance graph 300 depicts a stepwise chrominance precision function 306 that defines values based upon the luminance level associated with that pixel. One embodiment hereof incorporates a chrominance precision function defined to have values that increase as the luminance level associated with a pixel varies from the minimum luminance value or the maximum luminance value to an intermediate luminance value 308. The illustrated chrominance precision versus luminance graph 300 has an intermediate luminance value 308 of 128, for example, which is between the maximum luminance value 312 of 255 in this example and the minimum luminance value 310 of zero for this example.

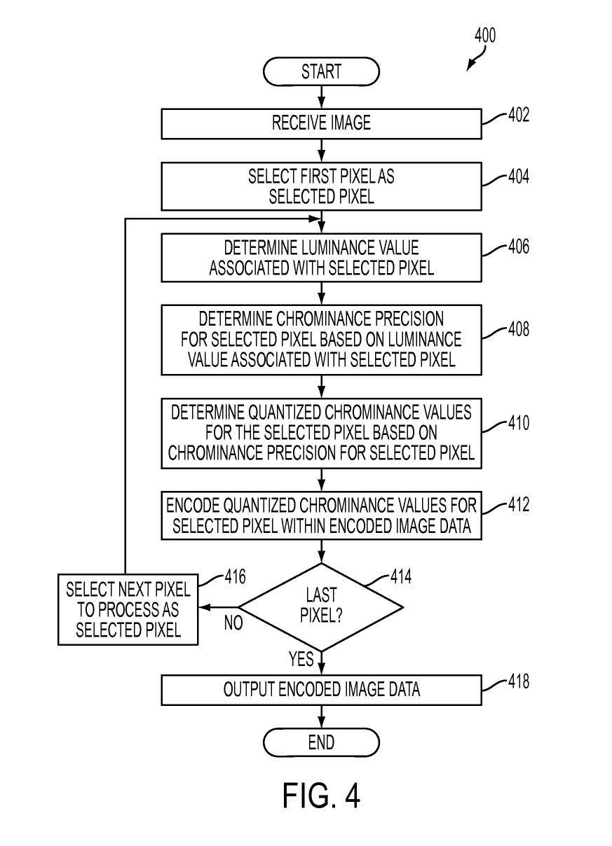

Reference is now made to FIG. 4, which is an image encoding method flow diagram of one embodiment of the present method.

The image encoding method 400 begins by receiving, at 402, a digital image to be encoded. The digital image can be received using, for example, an digital image scanner as is normally found in the arts. Alternatively, pixel values of an image are received over a network or retrieved from an image storage device. At 404, a first pixel is selected as a selected pixel within the received digital image. In embodiments operating with, for example, JPEG or MPEG data, the first pixel block is selected at step 404. At 406, a luminance level associated with the selected pixel or the selected pixel block is determined. At 408, a degree of chrominance precision for the selected pixel or pixel block is determined based upon the associated luminance level associated with the selected pixel or pixel block. Determination of the associated luminance level associated with a particular pixel is described above, and is able to be based upon the luminance value of the pixel, a combination of luminance values of pixels within a pre-defined neighborhood, or both. An example relationship between determined chrominance precision for a pixel and the associated luminance levels associated with that pixel is described above with respect to FIG. 3.

At 410, quantized chrominance values for the selected pixel within the received image are determined using the determined degree of chrominance precision. One embodiment determines quantized chrominance values using quantization tables 106, as is described above. Further embodiments encode the chrominance values of the received image to determined quantized chrominance values by, for example, truncating the chrominance values to have the determined degree of chrominance precision. In an example of a received image that includes pixels that have chrominance values specified using eight bits each, a pixel determined to have a degree of chrominance precision of five bits, based upon the associated luminance level associated with that pixel, has the eight bit chrominance values of that pixel truncated to five bits. In a further example of an embodiment operating with, for example, JPEG or MPEG data formats, the DCT outputs for each pixel block are quantized with a quantization matrix that is selected based upon the selected degree of chrominance precision. At 412, these chrominance values are stored as quantized chrominance values or, in the case of JPEG or MPEG data, the quantized DCT output values are entropy encoded according to the JPEG or MPEG standard. At 414, a decision is made if the current selected pixel or pixel block is the last pixel or pixel block to be processed within the received image. If this decision is false, a next pixel or pixel block to be processed is selected, at 416, to be the selected pixel or pixel block. If the decision determined the selected pixel to have been the last pixel to be processed, an encoded image, containing pixels with quantized chrominance values encoded according to the degree of chrominance precision determined for each pixel, is output, at 418. The processing then ends.

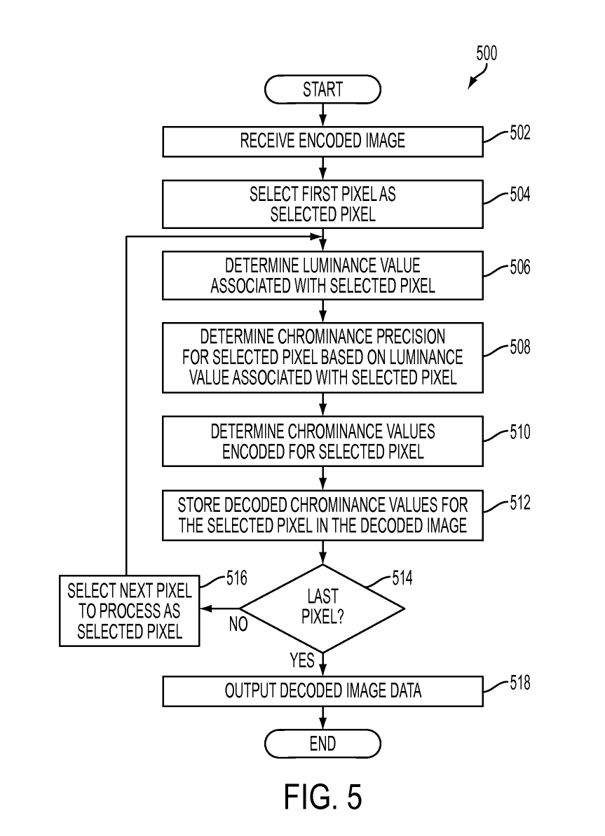

Reference is now made to FIG. 5, which is an image decoding method flow diagram of one embodiment of the present method.

The image encoding method 500 begins by receiving, at 502, an encoded digital image that has pixels with chrominance values encoded with a chrominance precision that was determined based upon the associated luminance level associated with that pixel. The decoding processing described herein uses the same luminance values as were used by the encoding processing to create the encoded image data being processed. The processing proceeds to select, at 504, a selected pixel or pixel block within the received encoded image. The method then determines, at 506, the luminance value associated with the selected pixel or pixel block. As described above, the image encoding processing did not change the luminance data so the encoded luminance data for the received encoded image is able to be used to determine the luminance data used by the encoding process.

A chrominance precision for the selected pixel is determined, at 508, based upon the luminance value associated with the selected pixel or pixel block. As described above with regards to image encoding, the luminance value associated with a pixel is able to be the luminance value of that pixel, a combination of luminance values of pixels within a neighborhood of the selected pixels, or both. Further embodiments use the DC value of the luminance DCT data of the received encoded image as the luminance value associated with the pixel block being decoded. The chrominance values of the selected pixel within the received encoded image are determined, at 510.

In one embodiment, these chrominance values of the selected pixel are extracted from the received encoded image based upon the determined chrominance precision. For example, based upon the luminance value associated with the selected pixel, the encoding algorithm used for this encoded image would use, for example, five bits to encode chrominance values for the selected pixel. It is to be noted that the encoding processing does not change the encoded luminance values for the encoded image data, so that the luminance values for various pixels are able to be reliably determined and used to determine chrominance precision for the selected pixels. After determining that the quantized chrominance values for the selected pixel were encoded using five bits, the data stream defining the received encoded image is then processed to extract the next pair of five bit values and those values are expanded to the data value range used for the decoded image data.

Further embodiments operating with JPEG or MPEG data are able to process the received encoded image by, for example, performing entropy decoding of the chrominance data and extracting the quantized pixel blocks for the received encoded image. The luminance data of the received encoded image is able to be processed in any suitable order to support chrominance date decoding. Embodiments that quantize the chrominance data as part of the encoding process, e.g., embodiments that do not alter quantization matrices, are able to apply the proper processing to recover the DCT values of the chrominance data for each pixel block. Embodiments that use different quantization matrices for each pixel block based upon a luminance value of that pixel block recover the un-quantized DCT values of the chrominance data for each pixel block by using the proper quantization matrix based upon the luminance value of that pixel block. An inverse-DCT is then performed on the un-quantized data.

At 512, the decoded chrominance values for the selected pixel are stored in the decoded image data. At 514, a decision is made if the current selected pixel is the last pixel to be processed within the received encoded image. If this decision is false, a next pixel is selected, at 516, to be the selected pixel. If the decision determined the selected pixel to have been the last pixel to be processed, a decoded image, containing pixels with chrominance values that were decoded according to the chrominance precision determined to have been used for each pixel, is output, at 518. The processing then ends.

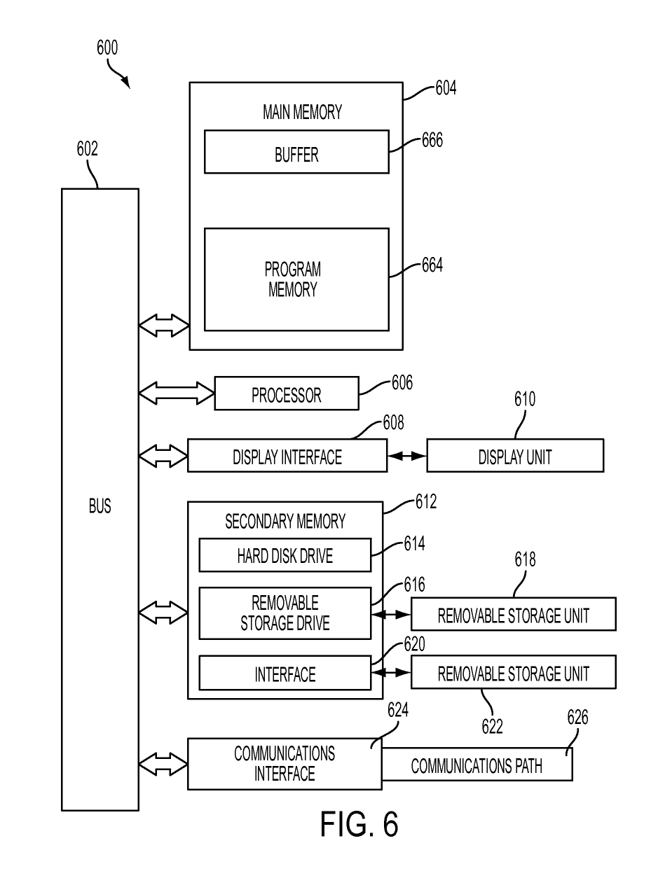

Reference is now made to FIG. 6 which illustrates a block diagram of one example embodiment of a special purpose computer useful for implementing one or more aspects of the present method. Such a system could be implemented as a separate computer system, an electronic circuit, or an ASIC, for example. The nature of the implementation will depend on the processing environment wherein the present method finds its intended uses. The special purpose computer system would execute machine readable program instructions for performing various aspects of the present method as described in the illustrated embodiments of FIG. 1, and the flow diagram of FIGS. 4 and 5.

Special purpose computer system 600 includes processor 606 for executing machine executable program instructions for carrying out all or some of the present method. The processor is in communication with bus 602. The system includes main memory 604 for storing machine readable instructions. Main memory may comprise random access memory (RAM) to support reprogramming and flexible data storage. Buffer 666 stores data addressable by the processor. Program memory 664 stores machine readable instructions for performing the present method. A display interface 608 forwards data from bus 602 to display 610. Secondary memory 612 includes a hard disk 614 and removable storage device 616 capable of reading/writing to removable storage unit 618, such as a floppy disk, magnetic tape, optical disk, etc. Secondary memory 612 may further include other mechanisms for allowing programs and/or machine executable instructions to be loaded onto the processor. Such mechanisms may include, for example, a storage unit 622 adapted to exchange data through interface 620 which enables the transfer of software and data. The system includes a communications interface 624 which acts as both an input and an output to allow data to be transferred between the system and external devices such as a color scanner (not shown). Example interfaces include a modem, a network card such as an Ethernet card, a communications port, a PCMCIA slot and card, etc.

Terms such as, computer program medium, computer readable medium, computer executable medium, and computer usable medium are used herein to generally refer to a machine readable media such as main memory, secondary memory, removable storage device such as a hard disk, and communication signals. Such computer program products are means for carrying instructions and/or data to the computer system or device. Such computer program products may include non-volatile memory, such as a floppy disk, hard drive, memory, ROM, RAM, flash memory, disk memory, and other storage useful for transporting machine readable program instructions for executing the present method. It may further include a CD-ROM, DVD, tape, cassette, or other digital or analog media, capable of having embodied thereon one or more logical programming instructions or other machine executable codes or commands that implement and facilitate the function, capability, and methods disclosed herein.

It should be understood that the flow diagrams hereof are intended to be illustrative. Other operations may be added, modified, enhanced, or consolidated. Variations thereof are intended to fall within the scope of the appended claims.

It should be understood that one or more aspects of the present method are intended to be incorporated in an article of manufacture, including one or more computer program products. The article of manufacture may be included on a storage device readable by a machine architecture, xerographic system, color management or other image processing system, any of which capable of executing program instructions containing the present method. Such an article of manufacture may be shipped, sold, leased, or otherwise provided separately either alone or as part of an add-on, update, upgrade, download, or product suite by the assignee or a licensee hereof as part of a computer system, xerographic system, document processing system, image processing system, color management system, operating system, software program, plug-in, DLL, or a storage device.

It will be appreciated that the above-disclosed features and function and variations thereof may be desirably combined into many other different systems or applications. Various presently unforeseen or un-anticipated alternatives, modifications, variations, or improvements may become apparent and/or subsequently made by those skilled in the art which are also intended to be encompassed by the appended claims. The embodiments set forth above are considered to be illustrative and not limiting. Various changes to the above-described embodiments may be made without departing from the spirit and scope of the invention.

What is claimed is:

1. A computer implemented method for encoding chrominance of a digital color image, the method comprising:
receiving, using an image input device, a digital color image comprising a plurality of pixels each having an associated luminance value and at least one associated chrominance value; and
for each selected pixel in said received color image:
determining a respective degree of chrominance precision for said selected pixel, said determination being based upon said selected pixel's associated luminance value;
quantizing said at least one chrominance value associated with said selected pixel to obtain a quantized chrominance value for said at least one chrominance value, said quantizing being based upon said selected pixel's determined degree of chrominance precision; and
outputting said quantized chrominance values for each of said selected pixels to a storage device.

2. The computer implemented method of claim 1, wherein said respective degree of chrominance precision has a substantially minimum value when said associated luminance level associated with said selected pixel is near any of a maximum luminance value and a minimum luminance value of said color gamut, said respective degree of chrominance precision increasing as said associated luminance level associated with said selected pixel varies away from said minimum luminance value and said maximum luminance value to an intermediate luminance value between said maximum and minimum luminance values.

3. The computer implemented method of claim 1, further comprising extracting said at least one quantized chrominance value for said selected pixel from a quantization table based upon any of said at least one chrominance value and said associated luminance level associated with said selected pixel.

4. The computer implemented method of claim 1, wherein said associated luminance level associated with said selected pixel is an average luminance value derived from luminance values of pixels in a pre-defined neighborhood of pixels surrounding said selected pixel.

5. The computer implemented method of claim 1, wherein said at least one chrominance value for said selected pixel comprises a first and second chrominance component, and wherein said degree of chrominance precision comprises a first and a second degree of precision for said selected pixel, said first chrominance component of said selected pixel being quantized with said first degree of chrominance precision and the second chrominance component of said selected pixel being quantized with said second degree of chrominance precision, said second degree of chrominance precision being different from said first degree of chrominance precision.

6. The computer implemented method of claim 5, wherein said first degree of chrominance precision is based upon a human eye sensitivity to said first chrominance component corresponding to said first chrominance value at said associated luminance value, and said second degree of chrominance precision is based upon a human eye sensitivity to said second chrominance component corresponding to said second chrominance component at said associated luminance value.

7. The computer implemented method of claim 1, further comprising outputting to a storage device, for each of said selected pixels in said received image, any of said associated luminance values, and said determined degree of chrominance precision.

8. The computer implemented method of claim 1, further comprising:
dividing the plurality of pixels into a series of pixel blocks;
determining, for each of the pixel blocks, a respective luminance discrete cosine transform for luminance values within the each of the pixel blocks; and
determining, for each of the pixel blocks, a respective at least one chrominance discrete cosine transform for the at least one chrominance values within the each of the pixel blocks, and
wherein the quantizing each of said at least one chrominance values comprises:
determining the respective degree of chrominance precision for pixels within each of the pixel blocks based upon a DC value of the respective luminance discrete cosine transform for luminance values within the each of the pixel blocks;
adjusting, based on the respective degree of chrominance precision, a degree of precision for encoding the respective at least one chrominance discrete cosine transform.

9. The computer implemented method of claim 8, wherein adjusting said degree of chrominance precision comprises adjusting a respective quantization matrix for each of the pixel blocks, the respective quantization matrix being used to set quantization levels for amplitude components of the chrominance discrete cosine transform of the each pixel block.

10. The computer implemented method of claim 8, further comprising:
entropy encoding of the respective at least one chrominance discrete cosine transform, and
adjusting said degree of chrominance precision by quantizing amplitude components of said chrominance discrete cosine transform of each pixel block prior to the entropy encoding.

11. A system for encoding chrominance of a digital color image, the system comprising:
a memory;
a storage medium for storing data; and
a processor in communication with said storage medium and said memory, said processor executing machine readable instructions for performing the method of:
receiving, using an image input device, a digital color image comprising a plurality of pixels each having an associated luminance value and at least one associated chrominance value; and
for each selected pixel in said received color image:
determining a degree of chrominance precision for said selected pixel, said determination being based upon said selected pixel's associated luminance value;
quantizing said at least one chrominance value associated with said selected pixel to obtain a quantized chrominance value for each of said at least one chrominance values, said quantizing being based upon said selected pixel's determined degree of chrominance precision; and
outputting said quantized chrominance values for each of said selected pixels to said storage medium.

12. The system of claim 11, wherein said degree of chrominance precision has a substantially minimum value when said associated luminance level associated with said selected pixel is near any of a maximum luminance value and near a minimum luminance value of said color gamut, said degree of chrominance precision increasing as said associated luminance level associated with said selected pixel varies away from said minimum luminance value and said maximum luminance value to an intermediate luminance value between said maximum and minimum luminance values.

13. The system of claim 11, further comprising extracting said at least one quantized chrominance value for said selected pixel from a quantization table based upon any of said at least one chrominance value and said associated luminance level associated with said selected pixel.

14. The system of claim 11, wherein said associated luminance level associated with said selected pixel is an average luminance value derived from luminance values of pixels in a pre-defined neighborhood of pixels surrounding said selected pixel.

15. The system of claim 11, wherein said at least one chrominance value for said selected pixel comprises a first and second chrominance component, and wherein said degree of chrominance precision comprises a first and a second degree of precision, said first chrominance component being quantized with said first degree of chrominance precision and the second chrominance component being quantized with said second degree of chrominance precision, said second degree of chrominance precision being different from said first degree of chrominance precision.

16. The system of claim 15, wherein said first degree of chrominance precision is based upon a human eye sensitivity to said first chrominance component corresponding to said first chrominance value at said associated luminance value, and said second degree of chrominance precision is based upon a human eye sensitivity to said second chrominance component corresponding to said second chrominance component at said associated luminance value.

17. The system of claim 11, further comprising outputting to a storage device, for each of said selected pixels in said received image, any of said associated luminance values, and said determined degree of chrominance precision.

18. A computer implemented method for encoding chrominance of a digital color image, the method comprising:
receiving, using an image input device, a digital color image comprising a plurality of pixels each having an associated luminance value and at least one associated chrominance value;
defining a neighborhood of pixels for a given pixel;
for each pixel in said received color image:
setting the each pixel as a selected pixel;
determining an associated luminance level for said selected pixel, said associated luminance level being an average luminance derived from luminance values of pixels in said defined neighborhood of pixels surrounding said selected pixel;
determining a degree of chrominance precision for said selected pixel, said determination being based upon said selected pixel's associated luminance value;
extracting, from a quantization table, at least one quantized chrominance value for said selected pixel, said extraction being based upon said determined associated luminance level; and
storing said quantized chrominance values of said selected pixel for said image to a storage device.

19. The computer implemented method of claim 18, wherein said degree of chrominance precision has a substantially minimum value when said associated luminance level associated with said selected pixel is near any of a maximum luminance value and a minimum luminance value of said color gamut, said degree of chrominance precision increasing as said luminance value associated with said selected pixel varies away from said minimum luminance value and said maximum luminance value to an intermediate luminance value between said maximum and minimum luminance values.

20. The computer implemented method of claim 18, wherein said at least one chrominance value for said selected pixel comprises a first and second chrominance component, and wherein said degree of chrominance precision comprises a first and a second degree of precision, and
wherein said first chrominance component being quantized with said first degree of chrominance precision and the second chrominance component being quantized with said second degree of chrominance precision, said second degree of chrominance precision being different from said first degree of chrominance precision.
